(19) United States
(12) Patent Application Publication
(10) Pub. No.: US 2022/0227519 A1
(43) Pub. Date: Jul. 21, 2022

(54) A PACKAGE SEAL CONTROL SYSTEM, AN UPGRADE KIT, AND A METHOD FOR MONITORING AND OPTIONALLY CONTROLLING THE LONGITUDINAL SEAL OF A PACKAGE MATERIAL IN A PACKAGING AND FILLING MACHINE

(71) Applicant: Tetra Laval Holdings & Finance S.A., Pully (CH)

(72) Inventors: Alessandro Brehas, Modena (IT); Luca Maltoni, Forli (IT); Ruben Martinez Garcia, Vattholma (SE)

(21) Appl. No.: 17/596,822

(22) PCT Filed: Jun. 23, 2020
(86) PCT No.: PCT/EP2020/067494

§ 371 Date: Dec. 17, 2021

(30) Foreign Application Priority Data
Jun. 27, 2019 (EP) 19182893.8

(51) Int. Cl. B65B 57/08; B65B 51/26; B65B 9/20

(52) U.S. Cl. CPC B65B 57/08; B65B 2051/105; B65B 9/20; B65B 51/26

(57) ABSTRACT

The present invention relates to a package seal control system (300), comprising a control unit (308), and data recording means (306) adapted to be communicatively connected to the control unit, wherein said data recording means (306) is adapted to monitor a longitudinal seal (302) extending in a direction conforming to a direction of flow of a packaging material (e.g. Tetra Pak) in a packaging and filling machine (100). The present invention further relates to its use and method for monitoring and optionally controlling the longitudinal seal (302) of a package material in a packaging and filling machine (100).

### TECHNICAL FIELD

The invention generally relates to the field of packaging technology, such as food packaging technology. More particularly, it is presented methods and apparatuses for controlling the longitudinal seal of carton-based packaging material for packages holding liquid food products.

### BACKGROUND

Today it is commonly known to use roll-fed packaging machines for different types of food products, e.g. milk. The roll-fed packaging machines, also referred to as filling machines, have several advantages. One is that a continuous production of packages makes it possible to achieve higher speeds compared to blanks-fed packaging systems. Another advantage is that by continuously filling a tube of packaging material and forming packages in a lower end of the tube, a risk that unwanted microorganisms enter the packages can be lowered.

The packaging material is provided with a longitudinal seal to form a tube. Thereafter, the tube shaped packaging material is filled with liquid food product, and finally transversal sealings are made to provide the final food package. The speed of the package forming is very high and the production is continuous. Thus, if something should happen to go wrong with e.g. the longitudinal sealing process the number of packages needed to be discarded is very high. Also, the production line may need to be shut down, adjusted, and cleaned and sanitized before production may be initiated again. This poses a substantial impact on product provision from an economic, environmental, safety, and time perspective.

Thus, there is a demand for finding better ways to ensure sufficient package performance.

### SUMMARY

It is an object to at least partly overcome one or more of the above-identified limitations of the prior art. In particular, it is an object to provide ways of controlling the longitudinal seal of packaging material in a packaging and filling machine. With the solutions provided herein a lot of time and resources may be minimized and the process control is increased. The down-time of the packaging machine is minimized, and the amount of waste, such as finished product waste, due to defect longitudinal sealings may be decreased in a sufficient manner. Also, the product safety and durability are better secured with the present solutions.

According to a first aspect it is provided a package seal control system comprising a control unit, and data recording means adapted to be communicatively connected to the control unit, wherein said data recording means 306 is adapted to monitor a longitudinal seal extending in a direction conforming to a direction of flow, of a packaging material.

According to a second aspect it is provided a package seal control upgrade kit to be applied on packaging and filling machines comprising a control unit, and data recording means communicatively connected to the control unit, wherein said data recording means is adapted to monitor a longitudinal seal extending in a direction conforming to a direction of flow of a packaging material in a packaging and filling machine.

When applying the package seal control upgrade kit on the packaging and filling machines according to this second aspect the package seal control system according to the first aspect can be achieved.

According to a third aspect it is provided a method for monitoring and optionally controlling a longitudinal seal of a package material in a packaging and filling machine, comprising the steps of:

providing a longitudinal seal to a package material using a sealing device, wherein opposite longitudinal side edges of a packaging material are provided with said seal to forming the packaging material into a tubular form, and the longitudinal seal extends in a direction conforming to a direction of flow of the packaging material;

monitoring the longitudinal seal of the package material in a tubular form using data recording means; and

optionally controlling the longitudinal seal of the package material in a tubular form using a control unit, wherein the control unit receives data from the data recording means and correlate the received data with at least a predetermined set point value to provide output data determining the longitudinal seal's condition, and optionally displaying the output data for a user, which user may be connected to a network.

According to a fourth aspect it is provided use of the package seal control system for monitoring and optionally controlling the longitudinal seal of a package material in a packaging and filling machine.

Still other objectives, features, aspects and advantages will appear from the following detailed description as well as from the drawings.

### SHORT DESCRIPTION OF THE DRAWINGS

Embodiments will now be described, by way of example, with reference to the accompanying schematic drawings, in which

FIG. 1 is a general illustration of a roll-fed packaging machine.

FIG. 2 is a schematic view of the pipings 200 including the encasing pipe 204 and filling pipe 104, 202.

FIG. 3 is a chart illustrating a method monitoring and controlling of the longitudinal sealing.

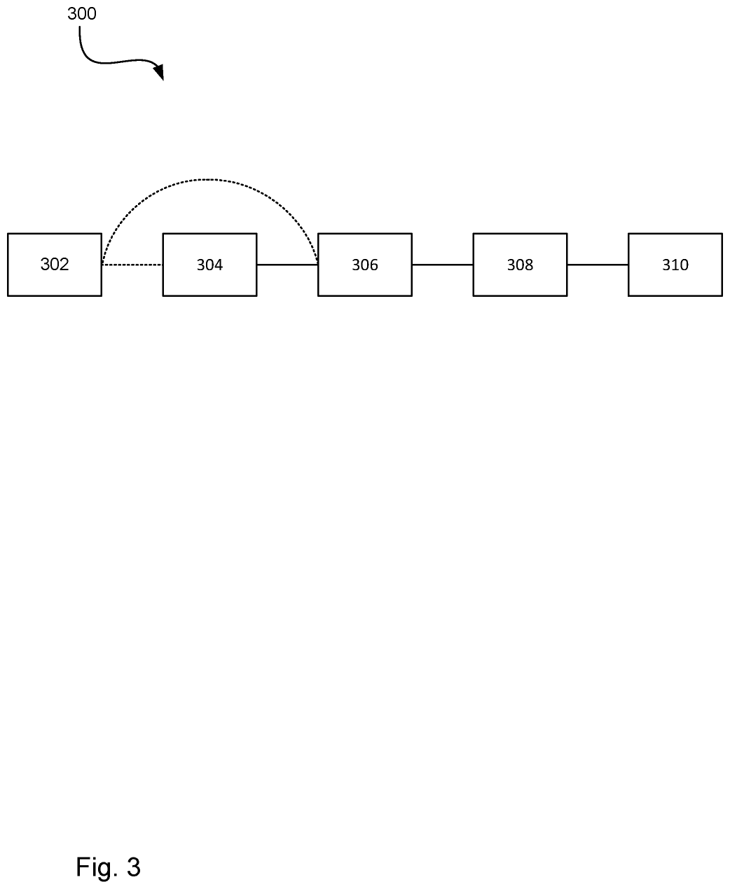

FIG. 4 illustrates a quality control system configured to perform a quality control of the longitudinal sealing according to one example.

FIG. 5 illustrates how arrays of data can be compared in the quality control system.

FIG. 6 illustrates another example of the quality control system.

### DETAILED DESCRIPTION

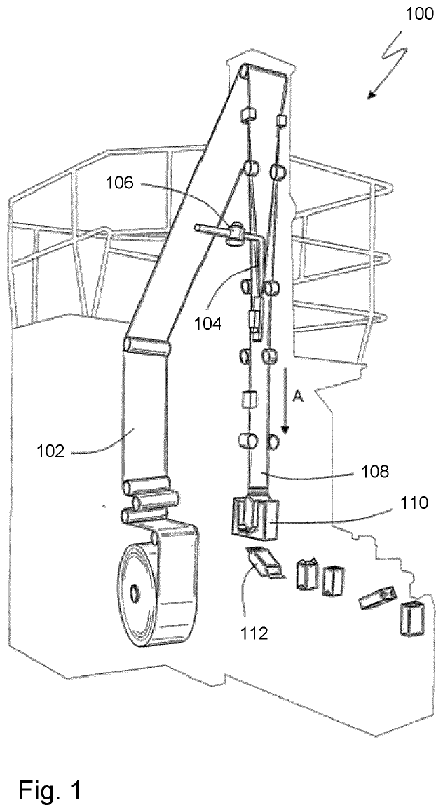

With reference to FIG. 1, a packaging machine 100, sometimes also referred to as a filling machine, is generally illustrated by way of example. The packaging machine 100 is a roll-fed packaging machine used for packaging liquid food products in carton-based packages. Already in the 1940s this type of packaging machines was introduced by Tetra Pak, and it is today a well-known approach for packaging milk and other liquid food products in a safe and cost-efficient manner. The general approach can also be used for non-liquid food products, such as potato crisps.

Today, packaging material is often printed and prepared in packaging material production centers, also referred to as converting factories, and is shipped to a site where the packaging machine 100 is placed, e.g. a dairy. Usually the packaging material is loaded onto a reel before being transported. After arriving at the site, the reel is placed in the packaging machine as illustrated in FIG. 1.

During production a web 102 of packaging material can be fed from the reel through the packaging machine in a web feeding direction A. Even though not illustrated in FIG. 1, the packaging material may pass through a sterilization device, e.g. a hydrogen peroxide bath or an LVEB (Low-Voltage Electron Beam) station, for ensuring that the web 102 is free from unwanted microorganisms. Before providing the food product, a tube can be formed from the web 102 by forming a longitudinal sealing. The food product can be fed into the tube via a filling pipe 104 and a valve 106 may be used for regulating a flow through the filling pipe 104. A lower end 108 of the tube can be fed into a folding device 110 in which a transversal sealing is made, the tube is folded according to folding lines, also referred to as weakening lines, and cut off such that packages 112 can be formed. Even though the folding device 110 is illustrated as one single device, the folding device 110 may comprise a number of different devices.

The present invention relates to a package seal control system 300.

The system 300 comprises:

a control unit 308; and

data recording means 306 adapted to be communicatively connected to the control unit 308;

wherein said data recording means 306 is adapted to monitor a longitudinal seal 302 extending in a direction conforming to a direction of flow, also considered a web feeding direction A, of a packaging material.

The system 300 may comprise:

a control unit 308; and

data recording means 306 adapted to be communicatively connected to the control unit 308;

wherein said data recording means 306 is adapted to monitor a longitudinal seal 302 extending in a direction conforming to a direction of flow, also considered a web feeding direction A, of a packaging material exiting a longitudinal sealing device adapted to seal opposite longitudinal side edges of the packaging material into a tubular form.

The data recording means 306 adapted to monitor the longitudinal seal 302 may be positioned downstream of the longitudinal sealing device in a direction conforming to direction of flow of the packaging material. The data recording means 306 may be positioned in the vicinity of the longitudinal sealing device, such as above any liquid level of the sealed packaging material in a tubular form or before any transversal sealing device. The data recording means 306 may be positioned within an aseptic chamber containing said longitudinal sealing device, or outside said aseptic chamber of the packaging and filling machine 100.

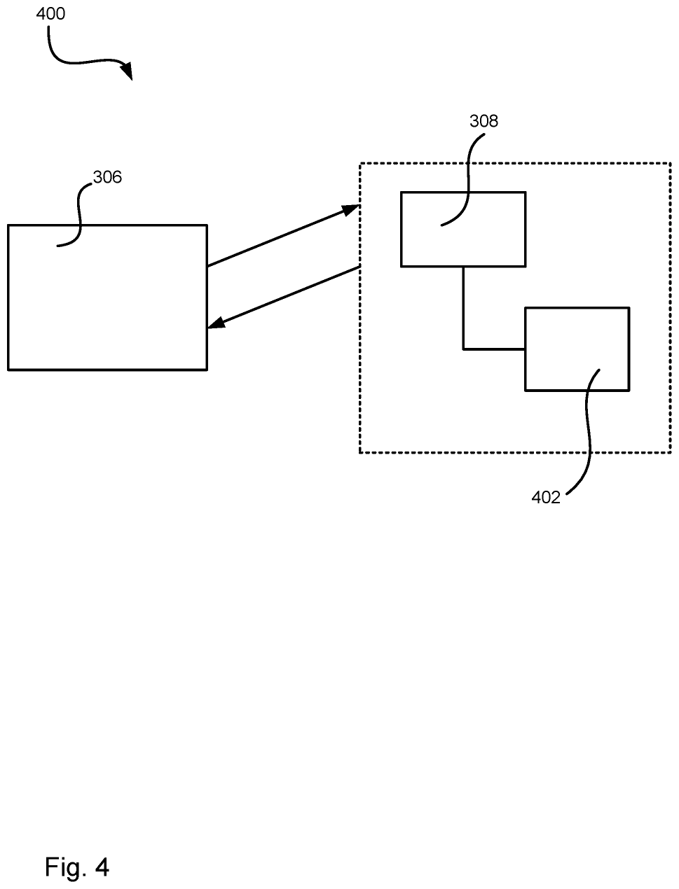

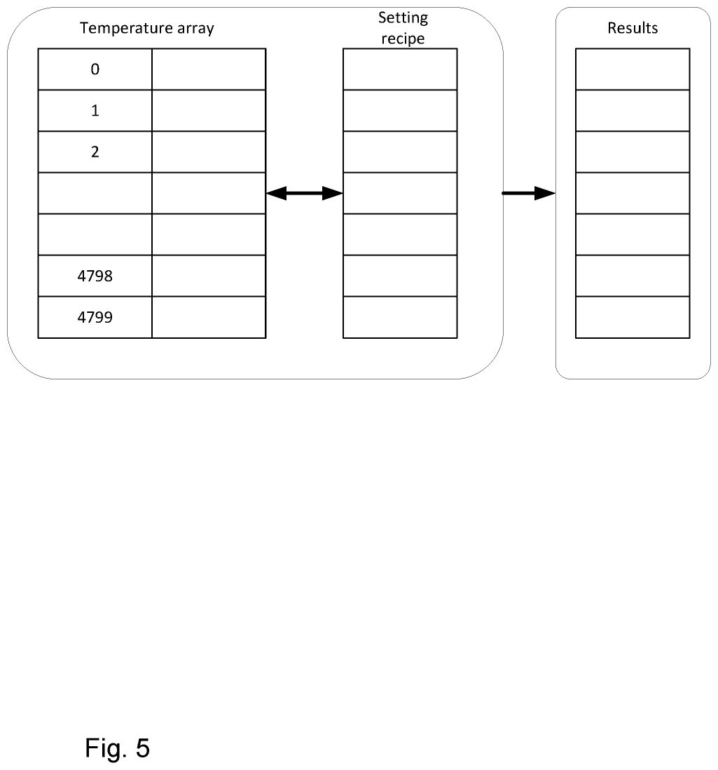

The data recording means 306 may comprise a camera or a vision system, preferably adapted to record coloring and/or an image as spectral data and spatial data of the longitudinal seal on said package material in tubular form. As a non-limiting example, the coloring may be directly related to a temperature. As yet another non-limiting example, the data recording means 306 may comprise a heat camera, which will be discussed in more detail in connection with FIGS. 4 and 5.

The data recording means 306 may be communicatively connected to the control unit 308 using wireless communication and/or wired communication.

The data recording means 306 may be positioned in the vicinity of the longitudinal sealing device to monitor the longitudinal seal 302 provided to package material. However, due to the conditions at and in the vicinity of the longitudinal sealing device where the longitudinal seal 302 is provided to the package material, it may be beneficial to not have the data recording means 306 positioned in the vicinity thereof. The available space around the longitudinal sealing device is very limited. In addition, the processing conditions and the safety requirements around the longitudinal sealing device may make it difficult to have data recording means 306 positioned there. The temperature may be quite high in said area of the longitudinal seal monitoring which may pose a problem for the data recording means.

The data recording means 306 may be connected to a fiber optic cable 304. The fiber optic cable 304 may be positioned to inspect the longitudinal seal 302 of the package material in tubular form.

The fiber optic cable 304 may in one end be connected to the data recording means 306 and in the opposite end adapted to monitor the longitudinal seal 302 extending in a direction conforming to a direction of flow of the packaging material. This means that the data recording means 306 adapted to monitor the longitudinal seal extending in a direction conforming to a direction of flow of the packaging material could be positioned outside the aseptic chamber. The fiber optic cable 304 connected to the data recording means 306 may in its other end be positioned in the vicinity of the longitudinal sealing device to monitor the longitudinal seal 302 provided to package material. The fiber optic cable 304 may be adapted to cope with and withstand the conditions at and in the vicinity of the longitudinal sealing device.

The package seal control system 300 may comprise a fiber optic cable 304, with one end attached to the data recording means 306, and the other end positioned downstream of the longitudinal sealing device in a direction conforming to direction of flow of the packaging material to allow monitoring of the longitudinal seal 302.

The package seal control system 300 may comprise an encasing pipe 204 adapted to enclose the fiber optic cable 304.

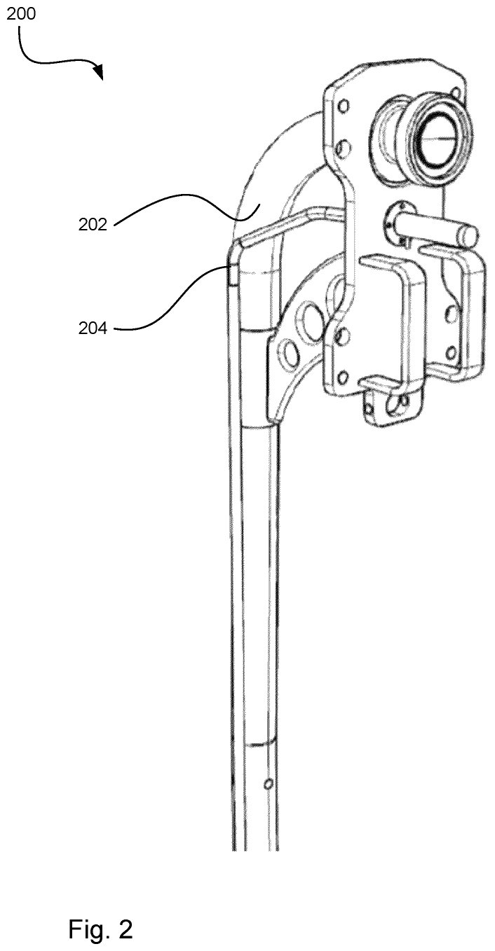

The fiber optic cable 304 may be adapted to fit in inside the encasing pipe 204. The encasing pipe 204 may be attached to a filling pipe 104, 202 of a packaging and filling machine 100. The encasing pipe 204 may be welded or glued to filling pipe 104, 202. FIG. 2 discloses a schematic view of the pipings 200 including the encasing pipe 204 and filling pipe 104, 202.

The fiber optic cable 304 may be positioned within the encasing pipe 204 for protecting the fiber optic cable 304 e.g. from the conditions within the aseptic chamber and/or conditions in the vicinity of the in the longitudinal sealing device. This way the fiber optic cable's area of contact to the conditions within the aseptic chamber and/or conditions in the vicinity of the in the longitudinal sealing device is minimized. For example, only the end of the fiber optic cable 304, preferably the utmost end, may be subjected to said conditions. Using the fiber optic cable 304 the data recording means 306 is able to monitor the conditions of the longitudinal seal 302 provided. The encasing pipe 204 may have many purposes whereof one is protecting the fiber optic cable. Another purpose of the encasing pipe 204 may be ease of sterilization of the equipment around the longitudinal sealing device, and maybe of the whole aseptic chamber surrounding the longitudinal sealing device.

The end of the fiber optic cable 304 not attached to said data recording means 306 may be attached to or inserted into a hole of the encasing pipe 204, said hole being provided downstream of the longitudinal sealing device in a direction conforming to direction of flow of the packaging material, preferably in the vicinity of the longitudinal sealing device. The hole of the encasing pipe 204 may be positioned above a liquid level of the longitudinally sealed package material.

The hole of the encasing pipe 204 may be positioned upstream an outlet of the filling pipe 104, 202 in a direction conforming to direction of flow of the packaging material.

The hole of the encasing pipe 204 may be positioned in the vicinity of the longitudinal sealing device, such as above any liquid level of the longitudinally sealed packaging material in a tubular form or before any transversal sealing device.

The package seal control system 300 may comprise a light source adapted to illuminate an area of the longitudinally sealed package material being monitored by the data recording means. A light source may be provided to allow better visual perception of the longitudinal seal provided. The light source may be positioned so that light is shed upon the longitudinal seal being monitored by the data recording means. The light source may be incorporated within the data recording means 306. If, the light source is incorporated into the data recording means 306, any fiber optic cable 304 connected to said data recording means 306 for use in monitoring the longitudinal seal may also be able to transmit light from the data recording means 306 to the other end of the fiber optic cable 304 to allow light to be shed over the longitudinal seal 302 being monitored.

The light source may use visible light, infrared (IR) light, ultraviolet (UV) light, or any combination thereof. The light source may provide visible light at wave lengths of about 380 to 740 nanometers (nm). The light source may provide IR light at wave lengths of about 740 nm to 1 mm. The light source may provide UV light at wave lengths of about 1 to 380 nm.

The light provided by the light source may be polarized. The polarization may be selected from linear polarization, circular polarization, elliptical polarization, or any combination thereof. When a package material contains a metal foil, e.g. aluminium foil, the use of polarized light may make the monitoring of the longitudinal seal easier in terms of detection of non-conformances.

The data recording means 306 is able to detect and record the colour, and image, i.e. shape and position, of the longitudinal seal. The colour and image are based on spectral data and spatial data gathered during the production of the longitudinal seal of the package material.

The control unit 308 may have a database, a file, a data processor for receiving data and correlate the received data on visual colour and/or image (spectral data and spatial data) with at least a predetermined set point colour and/or image (spectral data and/or spatial data) value, and displaying for a user, which user may be connected to a network.

The visual colour and/or image value provided from data recording means 306 in terms of spectral data and spatial data of the longitudinal seal may in the control unit 308 be compared and correlated with at least a predetermined set point colour and/or image value, which value is predetermined set point spectral data and/or spatial data of the longitudinal seal. The control unit 308 may further include further data to be used such as data for type of equipment, temperature ranges, seal type, and package, which may provide additional accuracy in the longitudinal seal assessment.

The control unit 308 may be connected to a remote control unit 310 via the network, the remote control unit 310 having user interface capability, so that data of the longitudinal sealing process may be transferred from the control unit 308 to be displayed for a user being connected to the remote control unit 310 via the network.

The remote control unit 310 may be located in a cloud-based computing environment. The remote control unit 310 may be a virtual control unit. The remote control unit 310 may have a database, a file, a data processor for receiving data and correlate the received data on visual colour and/or image (spectral data and spatial data) with at least a predetermined set point colour and/or image (spectral data and/or spatial data) value and displaying for a user connected to the network.

The control unit 308 having user interface capability, so that data of the longitudinal sealing process may be displayed for a user being connected to the control unit 308 via the network.

The control unit 308 may be adapted to control the longitudinal sealing device to adjust the amount of heating and/or electricity to produce the longitudinal seal, such as by increasing or decreasing the heating temperature and/or increasing or decreasing electricity amount.

The control unit 308 may be adapted to control packaging and filling machine to shut it down, and optionally start it up again, to allow the longitudinal sealing device to adjust the amount of heating and/or electricity to produce the longitudinal seal, such as by increasing or decreasing the heating temperature and/or increasing or decreasing electricity amount.

The package seal control system 300 may comprise a discarding device.

The control unit 308 may be adapted to control a discarding device, which discarding device is adapted to remove from the packaging and filling machine an amount of finished filled packages produced during a time period of defect longitudinal seal indicated by the control unit 308 based on received data correlated with said at least predetermined set point value(s).

The control unit 308 may contain a lot of data of the materials, and equipment used, including also positioning of the equipment, etc. The control unit 308 assists the data recording means 306 with interpretation of monitored findings. The control unit 308 may include predetermined or pre-set input data relating to type of packaging material and its constituents, positioning of the longitudinal seal, positioning of ends of the packaging material having been longitudinally sealed, power and electricity input for the longitudinal sealing, the type of light used, e.g. wavelength and/or optional polarization, etc. Such predetermined input data are then used together and correlated with the values obtained from the continuously monitoring of the longitudinal seal, as continuous monitored input data. The obtained output data from the correlation of the different input data may then be used to control the package seal system.

It is to be noted that machine learning algorithms may be included into the control unit 308 to allow improved accuracy of assessments overtime of the monitored longitudinal seal's spectral data and spatial data to provide improvements of the longitudinal seal's position, condition, and performance.

The present package seal control system 300, may comprise:

a longitudinal sealing device adapted to seal opposite longitudinal side edges of a packaging material into a tubular form, and a longitudinal seal 302 to extend in a direction conforming to a direction of flow A of the packaging material;

an encasing pipe 204 attached to a filling pipe 104, 202 of a packaging and filling machine 100;

a fiber optic cable 304 adapted to fit in the encasing pipe 204 attached to the filling pipe 104, 202;

data recording means 306, preferably containing a light source, attached to said fiber optic cable 304; and

a control unit 308;

wherein the fiber optic cable 304 is in one end attached to said data recording means 306 and in the other end attached to or inserted into a hole of the encasing pipe 204, said hole being provided downstream the longitudinal sealing device in a direction conforming to direction of flow of the packaging material, preferably in the vicinity of the longitudinal sealing device.

The present invention relates to a package seal control upgrade kit to be applied on packaging and filling machines, comprising:

a control unit 308; and

data recording means 306 communicatively connected to the control unit;

wherein said data recording means 306 is adapted to monitor a longitudinal seal 302 extending in a direction conforming to a direction of flow of a packaging material in a packaging and filling machine 100, wherein the packaging material may be exiting a longitudinal sealing device adapted to seal opposite longitudinal side edges of the packaging material into a tubular form. The data recording means 306 may comprise a camera or a vision system, preferably adapted to record colouring and/or an image, as spectral data and spatial data, of the longitudinal seal on said package material in tubular form. As a non-limiting example, the coloring may be directly related to a temperature. As yet another non-limiting example, the data recording means 306 may comprise a heat camera, which will be discussed in more detail in connection with FIGS. 4 and 5.

The package seal control upgrade kit may comprise a light source adapted to illuminate an area of the longitudinally sealed package material being monitored by the data recording means 306.

The package seal control upgrade kit may comprise a fiber optic cable 304, adapted to be attached with one end to the data recording means 306, and the other end positioned downstream of a longitudinal sealing device in the packaging and filling machine, in a direction conforming to direction of flow of the packaging material to allow monitoring of the longitudinal seal.

The package seal control upgrade kit may comprise an encasing pipe adapted to enclose the fiber optic cable, and preferably adapted to be attached to a filling pipe 104, 202 of the packaging and filling machine 100.

The present invention relates to a method for monitoring and optionally controlling a longitudinal seal 302 of a package material in a packaging and filling machine 100, comprising the steps of:

providing a longitudinal seal 302 to a package material using a sealing device, wherein opposite longitudinal side edges of a packaging material are provided with said seal to forming the packaging material into a tubular form, and the longitudinal seal extends in a direction conforming to a direction of flow of the packaging material;

monitoring the longitudinal seal 302 of the package material in a tubular form using data recording means 306; and

optionally controlling the longitudinal seal 302 of the package material in a tubular form using a control unit 308, wherein the control unit 308 receives data from the data recording means 306 and correlate the received data with at least a predetermined set point value to provide output data determining the longitudinal seal's condition, and optionally displaying the output data for a user, which user may be connected to a network.

The control unit 308 may further control the longitudinal sealing device to adjust the amount of heating and/or electricity to produce the longitudinal seal, such as by increasing or decreasing the heating temperature and/or increasing or decreasing electricity amount.

The control unit 308 may control the packaging and filling machine 100 to shut it down, and optionally start it up again, to allow the longitudinal sealing device to adjust the amount of heating and/or electricity to produce the longitudinal seal 302, such as by increasing or decreasing the heating temperature and/or increasing or decreasing electricity amount.

The control unit 308 may control a discarding device, which remove from the packaging and filling machine 100 an amount of finished filled packages produced during a time period of defect longitudinal seal indicated by the control unit 308 based on received data correlated with said at least predetermined set point value(s).

A fiber optic cable 304 may be used with the data recording means 306 for monitoring the longitudinal seal 302 of the package material in a tubular form. The method for monitoring and optionally controlling a longitudinal seal 302 of a package material in a packaging and filling machine 100, may comprise the steps of:

providing a longitudinal seal 302 to a package material using a sealing device, wherein opposite longitudinal side edges of a packaging material are provided with said seal to forming the packaging material into a tubular form, and the longitudinal seal extends in a direction conforming to a direction of flow of the packaging material;

monitoring the longitudinal seal 302 of the package material in a tubular form using a fiber optic cable 304 and data recording means 306 attached to said fiber optic cable 304; and

optionally controlling the longitudinal seal 302 of the package material in a tubular form using a control unit 308, wherein the control unit 308 receives data from the data recording means 306 and correlate the received data with at least a predetermined set point value to provide output data determining the longitudinal seal's condition, and optionally displaying the output data for a user, which user may be connected to a network.

Predetermined input data providing a predetermined set point value may be based on input relating to type of packaging material and its constituents, positioning of the longitudinal seal, positioning of ends of the packaging material having been longitudinally sealed, power and electricity input for the longitudinal sealing, the type of light used, e.g. wavelength and/or optional polarization, and experience relating to spectral and spatial data of longitudinal seal measurements, such as prior measurements made.

The data received by the control unit 308 from the recording means 306 and the predetermined set point value(s) may be based on visual colour and/or image. The received data on visual colour and/or image (spectral data and spatial data) may be correlated with at least a predetermined set point colour and/or image (spectral data and/or spatial data) value.

The fiber optic cable 304 may be provided downstream the longitudinal sealing device in a direction conforming to direction of flow of the packaging material.

The present invention relates to a method of evaluating the quality of a longitudinal seal of a liquid food package material comprising: providing a longitudinal seal to a package material,

monitoring the longitudinal seal of the package material to determine if the seal is defect in view of a predetermined value/threshold, which defect, if present, would increase the likelihood of spoilage of a liquid food product contained in a package of said package material.

The present package seal control system may be used for monitoring and optionally controlling the longitudinal seal of a package material in a packaging and filling machine 100.

The present package seal control upgrade kit may be installed at a packaging and filling machine 100 for monitoring and optionally controlling the longitudinal seal of a package material in said packaging and filling machine 100.

With reference to FIG. 4, a quality control system 400 configured to perform a quality control of the longitudinal sealing is illustrated by way of example. The quality control system 400 may comprise the data recording means 306, the control unit 308 and the database 402. The data recording means 306 may be configured to transmit image data to the control unit 308. The data recording means 308 may be configured to receive commands from the control unit 308. The control unit 308 may be configured to transmit information, e.g. the image data to the database 402. Further, the database 402 may be configured to store the information received from the control unit 308.

The packaging material is heated in order to be longitudinally and transversally sealed. The heating process can be done in different ways. If the material has a layer of aluminium, it may be possible to use induction technology. Further, it may also be possible to use hot air no matter which material it is used. The packaging material may have an outer plastic layer which may have the function to keep the product against from the carton material, but it may also be the function to seal the packaging material.

The sealing of the packaging material may need two surfaces which merge together. At least one of the surfaces is heated at a certain temperature to melt the plastic and be able to stick together with the other surface by pressure. In this process there may be different important factors. According to non-limiting examples, the important factors may be the temperature at which the material is heated, the area of which the material is heated, the speed of the heating process and the ambient temperature.

According to yet another non-limiting example, the important factors that may affect the quality of the sealing may preferably be the temperature and the area that is heated. By controlling these two parameters the sealing process may be secured with a higher probability.

In conventional systems there is not any integrated control in the filling machine neither of the temperature that the plastic surface of the packaging material nor if the area that is heated is the right one. There is only control of the energy delivered to the material (in case of aluminium material) or the temperature of the air that is used to heat the plastic surface. The quality control may then be done manually by the operators with a certain interval.

The present disclosure has the capacity to measure the temperature of the plastic of the packaging material, not only in one point but in all the area that is heated and also the surroundings. As previously disclosed, the data recording means 306 may comprise the heat camera. The heat camera may be installed close to the packaging material and after the heating element. According to a non-limiting example, the heat camera may be based on IR technology. The camera may be located so that it is focused on the area where the sealing must take place. The area has a rectangular shape, which is 4-5 times wider than the heated area and 2-3 times longer than the heated area. Thus, the heat camera may be configured to monitor the area of the packaging material that may be heated but also the surrounding area of the heated area.

The heat camera may be configured to measure a temperature of the packaging material. The checked area may be divided in small fractions which can be called pixels. Each pixel may be an individual temperature sensor. The temperature value represents the average temperature of that pixel area. The total area has a specific number of pixels wide and long. According to one non-limiting example, the pixels wide and long may be 80×60 pixels.

The camera may be installed at a certain distance from the packaging material. This distance may be important to calculate as well as to calibrate the dimension of the focused area. This dimension is calculated by the equation below:

W=D*tan(25)*2, wherein W is a wide distance and D is a distance from the camera to the surface, and

H=D*tan(19.5)*2, wherein H is a high distance and D is the distance from the camera to the surface.

Wherein each fraction of pixel may have then a certain dimension and this is calculated by:

Wp=W/80, wherein Wp is pixel wide, and

Hp=H/60, wherein Hp is pixel high.

Based on the type of packaging material and which machine that may be used, there may be a certain area that may be crucial to be heated at a specific temperature. This area has a rectangular shape and has a specific dimension. By mapping that area fraction by fraction with the heat camera it may be possible to monitor the entire area temperature.

The quality control system 400 illustrated in FIG. 4 may have a measuring interval of as fast as 27 milliseconds. In each capture the reading value of each pixel may be updated. The system can make a copy of all the values and store them in an array of data, together with the capturing timestamp. This array may then be transferred to the database 402. For each package volume and machine setup there may be a required sealing area and temperature that may be predefined in order to have a sealing with quality. That predefined area and temperature parameters may be saved in the memory of the control unit 308. When the quality control system 400 may be ready to run the control unit 308, it may choose the right recipe of parameters and transfer them to an array of data. Then this array may be compared with the current parameters when the material may be sealed, and the control unit 308 may calculate the deviations of temperature for all the pixels. This comparison is further illustrated in FIG. 5 by way of examples.

The concepts presented above may be described as a general method as follows:

A method for performing a quality control of a longitudinal seal of a packaging material, the method comprising:

mapping an area, fraction by fraction, of the packaging material using a heat camera;

generating a total area by combining each fraction of the mapped area;

dividing the total area into a plurality of pixels;

measuring, by using the heat camera and temperature sensors, a temperature of each pixel of the plurality of pixels;

generating a total temperature by combining each temperature of each pixel of the plurality of pixels;

comparing the total area with a predetermined sealing area and the total temperature with a predetermined temperature;

if a match is found between the two comparisons, the quality control of the longitudinal seal is approved.

The method may further comprise storing the total area and the total temperature in a database 402.

Even though being generally described above, different specific features described above with reference to FIG. 4 may be used be combined with the general method one by one or in combination. The same holds true with the other aspects and advantages described with reference to the other figures.

In line with the general method described above, the concepts may be described as a general system as follows:

A quality control system 400 configured to perform a quality control of a longitudinal seal of a packaging material, the quality system 400 comprising:

a heat camera configured to:
map an area, fraction by fraction, of the packaging material; and
measure a temperature of the mapped area of the packaging material;

a control unit 308 configured to:
receive the measured temperature and the mapped area from the heat camera 306; and

a database 402 configured to:
store the measured temperature and the mapped area.

Preferably, the heat camera may be configured to measure the temperature in the whole heated area. Preferably, the heat camera may be configured to measure the temperature in surroundings related to the heated area.

As for the general method, this general system may be combined with other features described with reference to FIG. 4 or any of the other figures. The general method and system may also be combined with features presented in the attached claims.

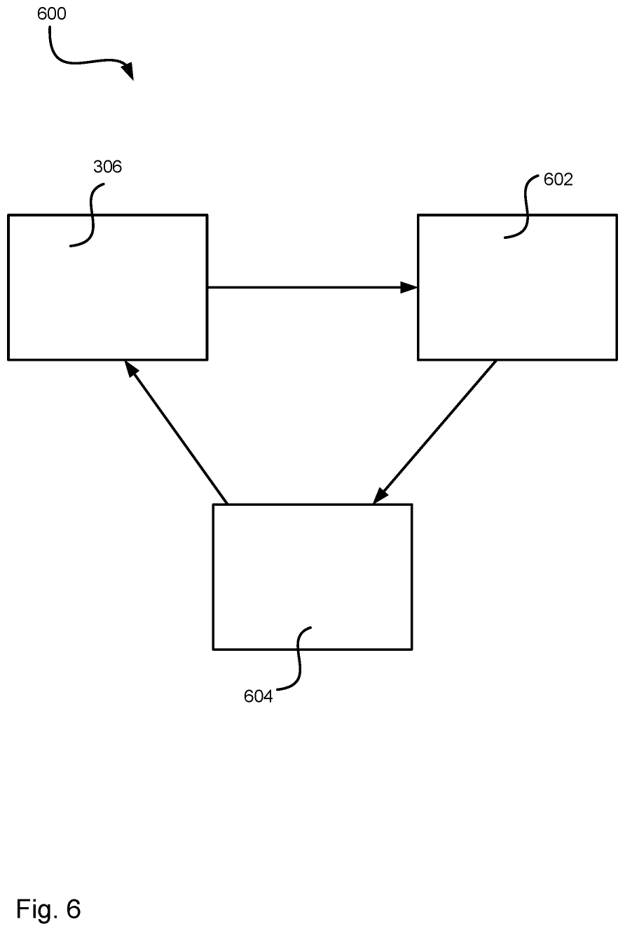

With reference to FIG. 6, a quality control system 600 configured to perform a quality control of a longitudinal seal of a packaging material is illustrated by way of examples. The quality control system 600 may comprise the data recording means 306, a machine controller 602 and a sealing process 604. The recording means 306 may be configured to transmit a temperature array transfer to the machine controller 602. The machine controller 602 may be configured to transmit a sealing power control to the sealing process 604. The sealing process may be configured to transmit a temperature reading to the recording device 306. As non-limiting examples, the results of the calculations can be used in three different ways. Thus, the controller can give an alarm and stop the machine if the sealing of the material is not correct or it can just give a warning and waste the packages that had not the right sealing quality. The results can be used as a process control parameter and adjust the power source setting to make a correction and minimize the deviation from the predefined temperature. It may be possible to check if the heating area is located in the correct place. If that may not be the case, there may be an adjusting device that moves the inductor or the heating element the distance needed to be moved in the right location. Concepts described above may be presented as a method as follows:

A method for performing a quality control of a longitudinal seal of a packaging material, the method comprising:

heating an area of the packaging material, wherein the heated area is configured to be sealed;

measuring, using a data recording means 306, a temperature of the heated area of the packaging material;

transmitting the temperature to a machine controller 602;

determining, in the machine controller 602, a sealing power control configured to adjust a sealing power;

transmitting the sealing power control to a sealing process 604, wherein the sealing process 604 may be adjusted based on the sealing power control.

The method may further comprise:

generating a temperature array based on the monitored temperature, wherein the monitored temperature may comprise one or several monitored temperatures;

comparing the temperature array with a predefined temperature array;

if a match is found between the temperature array and the predefined temperature array, the quality control may be accepted,

else, transmitting an alarm, from the machine controller 602, wherein the alarm may indicate that the quality control may be rejected.

The method may further comprise, if the quality control may be rejected:

adjusting power source setting in order to make a correction and minimize the deviation between the temperature array and the predefined temperature array.

The method may further comprise:

monitoring, using the data recording means 306, the heated area of the packaging material;

transmitting the heated area to the machine controller 602;

generating an area array based on the monitored area of the heated area;

comparing the area array with a predefined area array;

if a match is found between the area array and the predefined area array, the quality control may be accepted,

else, adjusting a heating element comprising an inductor such that a deviation between the area array and the predefined area array may be minimized.

In line with the method above, the concepts may be presented as a system as follows:

A quality control system 600 configured to perform a quality control of a longitudinal seal of a packaging material, the quality system 600 comprising:

a data recording means 306 configured to measure a temperature of the longitudinal seal of the packaging material and to monitor an area of the packaging material;

a machine controller 602 configured to, based on the measured temperature, determine a sealing power control of the longitudinal seal; and

a sealing process 604 configured to be adjusted based on the sealing power control.

An advantage with the disclosed quality control systems 400, 500 is that the knowledge of the quality of the longitudinal and transversal sealing may be improved. Thus, the quality control systems 400, 500 may be perform a quality control of the transversal sealing of the packaging material as well as the longitudinal sealing. A further advantage is that the control of the quality of the longitudinal and transversal sealing may be improved.

An advantage with the improved knowledge and control of the longitudinal and transversal sealing is that only packages that do not fulfil sealing requirements may be waste. In addition, the amount of package checks done by the operator may be reduced, and the time interval between the checks can be increased.

A yet further advantage is that it is possible to have a closed loop control of the sealing power and/or the sealing temperature. The feedback of the surface temperature is the key parameter to control the energy to be transferred to the packaging material. Thus, this will avoid machine stops.

A yet further advantage is that it is possible to have a closed loop control of the position of the sealing element and this make corrections on the fly avoiding machine stops.

The method and system presented above with reference to FIG. 6 may be combined with different features presented with reference to the other figures or the claims.

From the description above follows that, although various embodiments of the invention have been described and shown, the invention is not restricted thereto, but may also be embodied in other ways within the scope of the subject-matter defined in the following claims.

1. A package seal control system, comprising:
a control unit; and
a data recorder configured to be communicatively connected to the control unit;
wherein said data recorder is configured to monitor a longitudinal seal extending in a direction conforming to a direction of flow of a packaging material in a packaging and filling machine.

2. The package seal control system according to claim 1, wherein the data recorder comprises a camera or a vision system, preferably configured to record colouring and/or an image as spectral data and spatial data of the longitudinal seal on said package material in tubular form.

3. The package seal control system according to claim 1, further comprising a light source configured to illuminate an area of the longitudinally sealed package material being monitored by the data recorder.

4. The package seal control system according to claim 1, further comprising a fiber optic cable, with one end attached to the data recorder, and the other end positioned downstream of the longitudinal sealing device in a direction conforming to direction of flow of the packaging material to allow monitoring of the longitudinal seal.

5. The package seal control system according to claim 4, further comprising an encasing pipe configured to enclose the fiber optic cable, said encasing pipe preferably attached to a filling pipe of the packaging and filling machine.

6. The package seal control system according to claim 5, wherein a hole is provided in the encasing pipe, said hole configured to contain the end of the fiber optic cable not attached to said data recorder, said hole positioned upstream of an outlet of the filling pipe, or downstream of the longitudinal sealing device in a direction conforming to direction of flow of the packaging material, or above a liquid level of the longitudinally sealed package material.

7. The package seal control system according to claim 1, wherein the control unit has a database, a file, a data processor for receiving data and correlating the received data on visual colour and/or image value with a predetermined set point colour and/or image value, and displaying for a user, the user connected to a network.

8. The package seal control system according to claim 1, wherein the control unit is connected to a remote control unit via the network, the remote control unit having user interface capability, so that data of the longitudinal sealing process may be transferred from the control unit to be displayed for a user being connected to the remote control unit via the network.

9. A package seal control upgrade kit to be applied on packaging and filling machines, comprising:
a control unit; and
a data recorder configured to be communicatively connected to the control unit;
wherein said data recorder is configured to monitor a longitudinal seal extending in a direction conforming to a direction of flow of a packaging material in a packaging and filling machine.

10. The package seal control upgrade kit according to claim 9, further comprising a light source configured to illuminate an area of the longitudinally sealed package material being monitored by the data recorder.

11. The package seal control upgrade kit according to claim 9, further comprising a fiber optic cable, with one end configured to be attached to the data recorder, and the other end configured to be positioned downstream of a longitudinal sealing device in the packaging and filling machine, in a direction conforming to direction of flow of the packaging material to allow monitoring of the longitudinal seal.

12. The package seal control upgrade kit according to claim 9, further comprising an encasing pipe configured to enclose the fiber optic cable, said encasing pipe provided with a hole, said hole configured to contain the end of the fiber optic cable not attached to said data recorder.

13. A method for monitoring and optionally controlling the longitudinal seal of a package material in a packaging and filling machine, comprising the steps of:
providing a longitudinal seal to a package material using a sealing device, wherein opposite longitudinal side edges of a packaging material are provided with said seal to form the packaging material into a tubular form, and the longitudinal seal extends in a direction conforming to a direction of flow of the packaging material;
monitoring the longitudinal seal of the package material in a tubular form using a data recorder; and
controlling the longitudinal seal of the package material in a tubular form using a control unit, wherein the control unit receives data from the data recorder and correlates the received data with at least a predetermined set point value to provide output data determining the longitudinal seal's condition, and displaying the output data for a user, which user may be connected to a network.

14. The method according to claim 13, further including controlling, via the control unit, the longitudinal sealing device to adjust the amount of heating and/or electricity to produce the longitudinal seal, by increasing or decreasing a heating temperature and/or increasing or decreasing an electricity amount.

15. The method according to claim 13, further including controlling, via the control unit, the packaging and filling machine to shut it down, and start it up again, to allow the longitudinal sealing device to adjust the amount of heating and/or electricity to produce the longitudinal seal, by increasing or decreasing the heating temperature and/or increasing or decreasing electricity amount.

16. The method according to any claim 13, further including controlling, via the control unit, a discarding device, which removes from the packaging and filling machine an amount of finished filled packages produced during a time period of defect longitudinal seal indicated by the control unit based on received data correlated with said at least predetermined set point value(s).

17. A method of using the package seal control system according to claim 1, to monitor the longitudinal seal of a package material in a packaging and filling machine.

18. The method of claim 17, wherein the package control system is used to control the longitudinal seal of a package material in a packaging and filling machine.
